(19) United States
(12) Patent Application Publication
(10) Pub. No.: US 2001/0001793 A1
(43) Pub. Date: May 24, 2001

(54) Thermally stable hexabromocyclododecane fire retardants

(76) Inventors: Jacob Scheinert, Omer (IL); Yoav Bar-Yaakov, Beer-Sheva (IL); Pierre Georlette, Omer (IL)

Correspondence Address: LERNER, DAVID, LITTENBERG,, KRUMHOLZ & MENTLIK, 600 SOUTH AVENUE WEST, WESTFIELD, NJ, 07090, US

(21) Appl. No.: 09/732,635

(22) Filed: Dec. 8, 2000

Related U.S. Application Data
(63) Continuation of application No. 09/029,701, filed on Mar. 6, 1998.
Application No. 09/029,701 is a 371 of international application No. PCT/IL96/00100, filed on Sep. 5, 1996.

(30) Foreign Application Priority Data
Sep. 7, 1995 (IL) 115204
Nov. 6, 1995 (IL) 115881

(51) Int. Cl. C08K 5/01

(52) U.S. Cl. 524/474

(57) ABSTRACT

The present invention discloses a novel fire retardant composition that includes hexabromocyclododecane (HBCD) and an epoxy resin, including halogenated bisphenolic epoxy resins, halogenated phenol novolac epoxy resins, halogenated cresol novolac epoxy resins, halogenated resorcinol epoxy resins, halogenated hydroquinone epoxy resins, halogenated bisphenol A novolac epoxy resins, halogenated methyl resorcinol epoxy resins and halogenated resorcinol novolac epoxy resins, where the epoxy resin has an epoxy equivalent ranging from 150 to 800 g/eq. The addition of the epoxy resin improves heat stability of HBCD, allowing an increase in the processing temperature.

### CROSS-REFERENCE TO RELATED APPLICATIONS

The present application claims priority of co-pending and co-assigned U.S. patent application No. 09/029,701 filed Mar. 6, 1998, which claims priority of International Application No. PCT/IL96/00100, having an international filing date of Sep. 5, 1996.

### FIELD OF THE INVENTION

This invention refers to hexabromocyclododecane (hereinafter HBCD) fire retardants, having improved thermal stability and to polymeric compositions comprising said fire retardants. More particularly, it relates to such fire retardants comprising HBCD and halogenated epoxy resins as thermal stabilizers of the HBCD.

### BACKGROUND OF THE INVENTION

Hexabromocyclododecane (HBCD) is a flame or fire retardant (hereinafter sometimes abbreviated as FR) widely used in polystyrene foams. One of the limitations of HBCD is its low thermal stability. A good thermal stability is particularly important when plastic goods are manufactured by extrusion of polystyrene foams or by injection molding of dense high impact polystyrene and polypropylene. Common grades of HBCD are starting to decompose thermally at about 150° C., and to avoid corrosion of the processing equipment it is necessary to add large quantities (usually more than 5% by weight) of expensive thermal stabilizers. Such thermal stabilizers are lead dibasic phthalate, tin maleates, epoxies and polyepoxide compounds. One of the problems with these stabilizers is health hazards which limit their use. For instance, a polyepoxide such as the tris(2,3,-epoxypropyl)isocyanurate (TEPIC), which is potentially carcinogenic, must be used with great precaution. Further, the use of lead stabilizers is often banned or strictly limited in many industrialized countries.

Another way to obtain HBCD with better thermal stability is to produce a purified grade known as high-melting one, which is more expensive.

The HBCD grades having improved thermal stability, known in the prior art, can be processed usually at temperatures up to 200-210° C. provided the time during which they are exposed to such temperatures is short enough. Nevertheless, even said improved thermal stability is not sufficient for many applications.

It is a purpose of this invention to provide grades of HBCD fire retardants having better thermal stability than those of the prior art, thereby permitting the use of higher processing temperatures and/or longer residence times at high temperature.

It is another purpose of this invention to produce polymeric compositions, in particular, polystyrene or polyolefin compositions, having improved thermal and color stability.

Other purposes and advantages of this invention will appear as the description proceeds.

### SUMMARY OF THE INVENTION

The purposes of the invention are surprisingly achieved by using, as thermal stabilizers for flame retardant compositions comprising HBCD, epoxy resins which are halogen-substituted (halogen being bromine or chlorine), said halogenated resins having an epoxy equivalent in the range between 150 and 800 g/eq.

The term epoxy equivalent, per standard nomenclature, refers to the molecular weight of a substance divided by the number epoxy groups contained in said substance.

Typically, said resins are selected from the group consisting essentially of halogenated bisphenolic epoxy resins, halogenated phenol novolac epoxy resins, halogenated cresol novolac epoxy resins, halogenated resorcinol epoxy resins, halogenated hydroquinone epoxy resins, halogenated bisphenol A novolac epoxy resins, halogenated methyl resorcinol epoxy resins, halogenated resorcinol novolac epoxy resins, etc. Most preferred are halogenated bisphenolic epoxy resins, characterized by an average degree of polymerization in the range between 0 to 4. Dibromobisphenol A, tetrabromobisphenol A, dichloro-bisphenol A, tetrachlorobisphenol A, dibromobisphenol F, tetrabromobisphenol F, dichlorobisphenol F, tetrachlorbisphenol F, dibromobisphenol S and tetrabromobisphenol S epoxy resins are typical examples of halogenated bisphenolic epoxy resins of the above defined most preferred group. A, F and S are acceptable notations for describing the bridge connecting the phenols in the bisphenol moiety. A, F and S designate a bridge formed by the condensation of two phenol rings with acetone, formaldehyde and sulfide, respectively.

Tetrahalobisphenol A diglycidyl ethers having the general formula

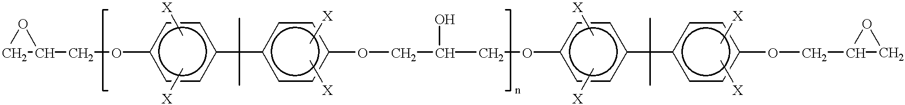

wherein n designates the average degree of polymerization, X is a halogen, said resin having an average molecular weight nor higher and preferably lower than 1600 g/mole, and wherein n, the average degree of polymerization can have any suitable value, provided it does not lead to an average molecular weight exceeding the said 1600 g/mole, are the most favored epoxy resins according to the present invention. Typically, n is comprised between 0 to 2, inclusive.

Tetrabromobisphenol A diglycidyl ethers, having the general formula

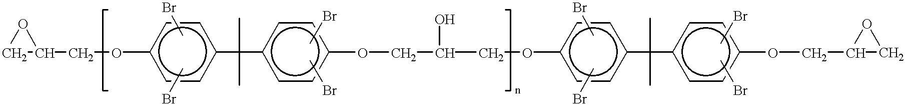

are yet even more favored epoxy resins according to the present invention, wherein n designates the average degree of polymerization, said resin having an average molecular weight not higher and preferably lower than 1000 g/mole, and wherein n, the average degree of polymerization can have any suitable value, provided it does not lead to an average molecular weight exceeding the said 1600 g/mole. Typically, n is comprised between 0 to 2, inclusive.

Processes for the preparation of the above described resins are described, for instance, in Polymer Synthesis, Vol. 1, S. R. Sandler and W. Karo, Academic Press Inc., ISPN 0-12-618502, pp. 80-81.

A novel crystalline form of Tetrabromobisphenol A diglycidyl ethers of the general formula

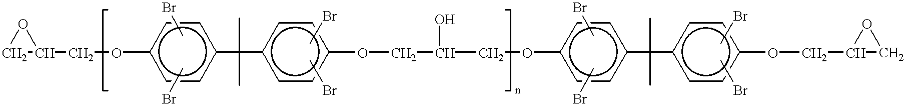

wherein n is comprised between 0 and 0.2, having an average molecular weight of about 700 g/mole and an epoxy equivalent weight of 320 to 380 g/eq, characterized by the presence, in the diffraction pattern, of the following seven strong diffraction peaks:

d-value, A

9.85

9.66

4.12

4.06

4.04

3.96

3.91

and by a softening point of about 100° C. to 120° C., was found to be particularly useful to serve as heat stabilizer for HBCD. The preparation of this crystalline form is illustrated hereinafter. Said novel crystalline form is the subject of a copending patent application of the same applicant herein.

It was surprisingly found that a significant increase in the thermal stability of HBCD is obtained when it is provided in a composition containing halogenated epoxy resins, compared with a similar composition of HBCD which contains nonhalogenated epoxies. The term “similar” refers to the content of the epoxy in the composition, which would be expected by skilled persons to be the parameter which governs the thermal stability of the final HBCD composition. The fact that halogenated epoxy resins are superior to nonhalogenated polyepoxide resins, in that they confer to HBCD compositions an improved thermal stability, for the same epoxy content in the compositions, constitutes a surprising aspect of the present invention.

Another completely unexpected effect according to the present invention involves the average molecular weight of the halogenated epoxy resin used to increase the thermal stability of the HBCD composition. Surprisingly, a better thermal stabilization for HBCD plural is reached when lower molecular weight halogenated epoxy resins are comprised therein, rather than higher weight ones, for a given epoxy content. The man of the art would have expected the contrary, since it appears logical to choose, as a thermal stabilizer component for an arbitrary composition, a substance which, a priori, has a higher degree of thermal stability in itself, and in the field of halogenated epoxy resins, it is known that the higher the average molecular weight of a given resin, the higher its thermal stability: see “F-2000 Series of brominated polymeric additives (BPA), for polyamides, thermoplastic polyesters and thermosetting resins”, by R. Minke, Z. Nir and Y. Bar Yaacov, in “Flame retardants '83”. Preferably, according to the invention, the above-identified most favorite brominated epoxy resin used have an average molecular weight not higher and preferably lower than 1600 g/mole and more preferably comprised between 300 and 1500 g/mole.

The invention therefore, comprises flame retardant (hereinafter, sometimes, FR) compositions comprising at least 5% and preferably from 10 to 60% of at least one halogenated epoxy resin, as hereinbefore defined, having the aforesaid characteristic, and, correspondingly, not more than 95% and preferably from 40 to 90% of HBCD. All percentages, in this application, are by weight, unless otherwise specified. The FR compositions may also comprise FR synergists, such as antimony trioxide, zinc borates, magnesium oxide or hydroxide, and other known FR synergists. The aforesaid percentages will refer, in that case, to the aggregate amount of halogenated epoxy resins and HBCD, viz., the halogenated epoxy resins and HBCD will be in the relative proportion of at least 5/95 and preferably from 10/90 to 60/40. The aggregate amount of halogenated epoxy resins and HBCD will be, in that case, at least 20% and preferably between 25 and 90% of the total weight of the FR composition. This includes also compositions of flame retardants masterbatch concentrates, i.e., previously prepared mixtures which will usually comprise high percentage of said compositions (together with a base material), and may be used as additives for various products.

Said fire retardant compositions, comprising halogenated epoxy resins, are thermally stable and improve the thermal stability, particularly in processing, of the polymeric compositions to which they are added, to a greater extent than the HBCD compositions known in the art. Furthermore, brominated epoxy resins are also much less health hazardous than other compounds which the art has suggested to add to HBCD to improve its thermal stability. It should also be noted that said resins are in themselves flame retardant additives, so that they have a dual function in the polymeric compositions; to stabilize the flame retardant HBCD against heat, and to contribute to the flame retardancy of the polymeric composition. On the other hand, rendering HBCD more thermally stabilized by simply increasing the amounts of the polyepoxide stabilizer, although theoretically possible, cannot be accomplished without reducing the flame retardancy properties of the HBCD composition, since, as it is known, said polyepoxide resins are highly flammable.

The invention also provides polymeric compositions, particularly based on or comprising polystyrene, styrene copolymers, polyolefins, PVC and rubbers, which comprise at least one halogenated epoxy resin and HBCD in an aggregate amount of at least 0.5% and preferably from 2 to 30% of the polymeric composition. The polymeric compositions of the invention may further comprise other FR compounds, as hereinbefore set forth. Further, they may comprise plastics additives other than fire retardants, such as thermal stabilizers which may be selected from phosphites, phenols and polyols or combinations thereof, antioxidants, lubricants, pigments, impact modifiers, processing aids, peroxides or other initiators, fillers, glass or carbon fiber reinforcements, plasticizers and other additives currently used in plastic compositions. Typically, the halogen content in the FR compositions is between 12 and 71% and in polymeric compositions it is between 0.3 and 22%.

### DETAILED DESCRIPTION OF PREFERRED EMBODIMENTS

Following examples illustrate preferred embodiments of the invention.

### [0031] EXAMPLE 1

A mixture of HBCD, manufactured and sold by Dead Sea Bromine Group under the denomination FR-1206, with different stabilizers, have been prepared and their thermal stability has been tested by determining, by dynamic thermogravimetric analysis under air, at a heating rate of 10° C. per minute, the temperatures at which weight losses of 5% and 10% have occurred to evaluate their efficiency. Table 1 shows clearly the much better thermal stability of the mixture comprising a brominated epoxy resin with an average molecular weight of 1000 g/mole and an epoxy equivalent of 500 g/eq and also of the mixture comprising a brominated epoxy crystallized with an average molecular weight of 700 g/mole and an epoxy equivalent of 350 g/eq as hereinbefore mentioned, in comparison with the mixtures comprising prior art thermal stabilizers. In this Table FR-1206 indicates a HBCD manufactured and sold by Dead Sea Bromine Group and the polyepoxide compound is characterized by an epoxy equivalent weight of 108 g/eq and is produced by Nissan.

It is seen that the mixture stabilized by the brominated epoxy resin is about 15 to 20° C. more stable than the others. Moreover, it should be observed that the fact that both systems based upon an epoxy stabilization have a similar epoxy content in the composition confirms the surprising thermal stabilization effect obtained by the use of the brominated epoxy resin. As the price of the polyepoxide compound used in this example is about U.S. $20/kg (August 1995) while the price of the brominated epoxy resin according to the invention is only U.S. $4/kg, another advantage of the invention is that the mixture stabilized by the brominated epoxy resin is less expensive.

TABLE 1
DYNAMIC THERMOGRAVIMETRIC ANALYSIS
(Under air 10° C./min.)

| | | Lead | Brominated | Crystallized |
|---|---|---|---|---|
| Type of | Polyepoxide | dibasic | epoxy | brominated |
| Stabilizer | compound | phthalate | resin | epoxy resin |
| Stabilizer | | | | |
| Epoxy | 108 | | 500 | 350 |
| equivalent | | | | |
| (g/eq) | | | | |
| Composition | | | | |
| FR-1206 | 93 | 95 | 70 | 70 |
| (= HBCD) | | | | |
| content (%) | | | | |
| Stabilizer | 7 | 5 | 30 | 30 |
| content in the | | | | |
| composition (%) | | | | |
| Bromine | 68.8 | 70.3 | 66.5 | 66.2 |
| content (%) | | | | |
| Epoxy content | 0.07 | | 0.06 | 0.085 |
| (mole/100 g) | | | | |
| Thermal Stability | | | | |
| 5% weight | 240 | 240 | 260 | 265 |
| loss (T, ° C.) | | | | |
| 10% weight | 243 | 250 | 265 | 270 |
| loss (T, ° C.) | | | | |

### [0034] EXAMPLE 2

The same FR compositions of Example 1 have also been compared by isothermal thermogravimetric analysis, evidencing once again a spectacular improvement for mixture of HBCD stabilized by a low average molecular weight brominated epoxy resin, according to the invention. This is shown in the following Table 2. In this Table FR-1206, brominated epoxy resin, crystallized brominated epoxy resin and polyepoxide compound have the same meanings as in Table 1.

TABLE 2
ISOTHERMAL THERMOGRAVIMETRIC ANALYSIS
(Under air)

| | | lead | | Crystallized |
|---|---|---|---|---|
| Type of | polyepoxide | dibasic | brominated | brominated |
| Stabilizer | compound | phthalate | epoxy resin | epoxy resin |
| Stabilizer | | | | |
| epoxy | 108 | | 500 | 350 |
| equivalent | | | | |
| (g/eq) | | | | |
| Composition | | | | |
| FR-1206 | 93 | 95 | 70 | 70 |
| (= HBCD) | | | | |
| content (%) | | | | |
| stabilizer | 7 | 5 | 30 | 30 |
| content in the | | | | |
| composition (%) | | | | |
| Bromine | 68.8 | 70.3 | 66.5 | 66.2 |
| content (%) | | | | |
| epoxy content | 0.07 | | 0.06 | 0.085 |
| (mole/100 g) | | | | |

Thermal Stability at T = 220° C.

| | | | | |
|---|---|---|---|---|
| Weight loss | 55 | 29 | 2.0 | 1.2 |
| after 20 min (%) | | | | |

Thermal Stability at T = 230° C.

| | | | | |
|---|---|---|---|---|
| Weight loss | 82 | * | 26.5 | 2.0 |
| after 20 min (%) | | | | |

*not checked

### [0036] EXAMPLE 3

The following example shows a comparison of the efficiency, as thermal stabilizers, of several brominated epoxy resins with increasing the average molecular weight and at various loadings. Table 3 summarizes the results. In Table 3, the denominations FR-1206 has the same meanings as in Table 1, brominated epoxy resin type I refers to brominated epoxy resin having an epoxy equivalent of 500 g/eq as in Table 1 and brominated epoxy resin type II has an average molecular weight of 1600 g/mole and an epoxy equivalent of 800 g/eq.

TABLE 3
ISOTHERMAL THERMOGRAVIMETRIC ANALYSIS
(Under air)

| Stabilizer | | |
|---|---|---|
| Type of Stabilizer | Brominated epoxy | Brominated epoxy |
| | resin type I | resin type II |
| Epoxy equivalent (g/eq) | 500 | 800 |

| | | | | | |
|---|---|---|---|---|---|
| Composition | | | | | |
| FR-1206 (=HBCD) | 85 | 80 | 75 | 70 | 70 |
| content (%) | | | | | |
| Stabilizer content | 15 | 20 | 25 | 30 | 30 |
| (%) | | | | | |
| Bromine content (%) | 70.2 | 69.0 | 67.7 | 66.5 | 66.5 |
| Epoxy content | 0.03 | 0.04 | 0.05 | 0.06 | 0.04 |
| (mole/100 g) | | | | | |
| Thermal stability at T = 220° C. | | | | | |
| Weight loss after 20 | 71 | 3 | 2 | 2 | 55 |
| min. (%) | | | | | |

From the above results, it can be seen that the thermal stabilization effect is very dependent on the average molecular weight and/or the epoxy equivalent of the brominated epoxy resin, which must be low. A slight increase of the average molecular weight from 1000 g/mole to 1600 g/mole has a strong detrimental effect on the weight loss under isothermal thermogravimetric analysis.

If can also be seen that at least 15% of a brominated epoxy resin of the right average molecular weight is necessary to obtain a very good thermal stability of the mixture.

### [0040] EXAMPLE 4

In an isothermal thermogravimetric analysis as described in Example 3, a commercial grade of HBCD was compared with a mixture according to the invention, comprising a stabilizer of type I as defined in Table 3. The results are shown in Table 4. CD 75 P is commercial grade of HBCD produced by the Great Lakes Chemical Company, which has a higher melting range than FR-1206. FR-1206 has the same meaning as in Table 1.

TABLE 4
ISOTHERMAL THERMOGRAVIMETRIC ANALYSIS
(Under air)

| Type of HBCD | FR-1206 | CD 75 P |
|---|---|---|
| Composition, % | | |
| HBCD | 70 | 100 |
| Brominated epoxy resin | 30 | 0 |
| Type I | | |
| Bromine content, % | 66.5 | 74 |
| Thermal stability at 220° C. | | |
| Weight loss after 20 min., % | 2 | 12 |

These results show that even high melting grades of HBCD are much less thermally stable than the mixtures of HBCD stabilized according to the invention.

### [0043] EXAMPLE 5

Various grades of stabilized HBCD have been mixed with pigmented crystal polystyrene. These blends have been processed during 5 minutes in a Brabender plastograph heated at 220° C. to control the color thermal stability. The molten blends were discharged from the plastograph and then compression molded to produce plates which were used for testing. The results shown in Table 5 confirm the better thermal stability of the mixture prepared according to the invention using a low average molecular weight brominated epoxy resin as the thermal stabilizer of HBCD. In the Table, the denominations brominated epoxy resin, polyepoxide compound and FR-1206 have the same meanings as in Table 1.

TABLE 5
COMPOUNDING OF CRYSTAL POLYSTYRENE FLAME
RETARDED BY STABILIZED GRADES OF HBCD

| | | |
|---|---|---|
| Type of stabilizer | Brominated | Polyepoxide |
| | epoxy resin | compound |
| FR composition, % | | |
| FR-1206 (HBCD) | 70 | 93 |
| Stabilizer | 30 | 7 |
| Bromine content, % | 66.5 | 63.8 |
| Plastic composition, % | | |
| Polystyrene crystal | 97 | 97 |
| stabilized HBCD | 3 | 3 |
| Properties | | |
| Color thermal stability | Very good | Fair |
| Flame retardancy UL 94, | V-2 | V-2 |
| rating | | |

UL 94 is a standard flame retardancy test of the Underwriters Laboratories and the V-2 rating is a measure according to said test.

Preparation A

500 G of a commercial diglycidyl ether of tetrabromobisphenol A, made from TBBA epichlorohydrine, as hereinbefore set forth, sold by Dead Sea Bromine Group Ltd., hereinafter F-2200, and having the following analysis:

Bromine content 48.5%

EEW (epoxy equivalent weight) 343 g/eq

Hydrolyzable chlorine 0.02%

Softening point 53° C.

was heated to 90° C., whereby a thick, viscous mass was obtained. The mass was intimately mixed with one g of crystalline F-2200. The material was then spread onto a stainless steel tray to form a layer 3 mm thick. The tray was placed into an oven and heated to 90° C. for 12 hours. The resulting product is a white crystalline solid with a softening point of 111° C. and fusion heat of 38 J/G.

Its diffraction pattern was determined as follows. X-ray data were obtained with the Phillips Diffractometer PW 1050/70, using Cu Ka radiation, Graphite monochromator, 40 Kv, 28 ma. The specific crystalline form of the product is characterized by the presence, in the diffraction pattern of the product, of the following seven strong diffraction peaks:

d-Value, A

9.85

9.66

4.12

4.06

4.04

3.96

3.91

### [0056] EXAMPLE 6

Table 6 illustrates the properties of HBCD mixtures stabilized with the crystalline solid form of diglycidyl ether of tetrabromobisphenol A of Preparation A and with brominated epoxy resins having an epoxy equivalent as detailed below.

TABLE 6
ISOTHERMAL THERMOGRAVIMETRIC ANALYSIS FOR HBCD
STABILIZED WITH BROMINATED EPOXY RESINS
(Under air)

| Stabilizer | | | |
|---|---|---|---|
| Epoxy equivalent (g/eq) | 343* | 500 | 800 |
| Composition | | | |
| HBCD content (%) | 85 | 85 | 85 |
| Stabilizer content (%) | 15 | 15 | 15 |
| Thermal Stability at T = 220° C. | | | |
| Weight loss after 20 min (%) | 3 | 71 | 72 |

*from preparation A

It is evidenced from these results that a mixture of HBCD with the above-identified crystalline solid form of diglycidyl ether of tetrabromobisphenol A exhibits excellent thermal stability, even when the ratio of the HBCD and the stabilizer comprised therein is 85:15. It was impossible to dry mix HBCD with the low melting F-2200 as it sticks to the mixer.

### [0059] EXAMPLE 7

Tables 7 and 8 illustrate a comparison between two types of thermally stabilized HBCD formulations.

One type is a composition according to the present invention consisting of 70% FR-1206 (HBCD, manufactured and sold by Dead Sea Bromine Group as hereinbefore defined) and 30% of the crystallized brominated epoxy resin of Preparation A. This type is hereinafter designated as FR 1206/crystBrEpox70:30. The second type is GREAT LAKES' heat-stabilized HBCD version, hereinafter SP-75.

The property compared is the thermal stability of said compositions, and the parameters measured are indicated in the tables.

The results clearly reflect the superior thermal stability of a composition comprising HBCD and crystallized brominated epoxy resin of Preparation A as stabilizer, in a ratio of 70:30, over stabilized HBCD versions known in the art.

TABLE 7
ISOTHERMAL THERMOGRAVIMETRIC ANALYSIS
(Under Air)

| Type of stabilized HBCD | FR 1206/CrystBrEpox70:30 | SP-75 |
|---|---|---|
| Thermal Stability at 230° C.: | 13-15 | 5-6 |
| Time to 5% Weight Loss (Min) | | |

TABLE 8
DYNAMIC THERMOGRAVIMETRIC ANALYSIS
(Under Air)

| Type of HBCD | HBCD/CrystBrEpox70:30 | SP-75 |
|---|---|---|
| Weight Loss %: | 68 | 86 |
| Total at 300° C. | | |
| Temp. to Weight Loss: | 265 | 248 |
| 5% Weight Loss (° C.) | | |

### [0064] EXAMPLE 8

The following example illustrates the properties of a polymeric composition according to the present invention comprising the HBCD-stabilized composition FR 1206/crystBrEpox70:30 of Example 7, compared with a similar polymeric composition comprising GREAT LAKES' heat stabilized HBCD version, SP-75 defined in Example 7.

The polymeric compositions are based on high impact polystyrene, hereinafter HIPS. The polymeric composition based on HIPS and FR 1206/CrystBrEpox70:30 will be designated hereinafter as HIPS+FR 1206/CrystBrEpox70:30. The polymeric composition based on HIPS and SP-75 will be designated hereinafter as HIPS+SP-75.

The property compared was the heat stability during processing of such polymeric compositions, which is reflected by the intensity of the color developed during said processing: the higher the intensity, the lower the stability, as will be hereinafter explained. The parameter actually measured is the DE value, a dimensionless quantity which indicates the deviation of a given color from absolute white. Determining the DE value of a substance at different time serves, therefore, as an indication for changes in the color of said substance which are due to the processing it is subjected to, and thereby teaches about thermal stability in the course of processing.

The comparison is made as follows: subsequent to the compounding of few grades of stabilized HBCD with HIPS on BERSTORFF ZE25 twin-screw extruder having L/D (length/diameter) ratio of 32:1 at a mild temperature not exceeding 210° C., the compounds thus obtained were injection molded on an ARBURG Allrounder injection molding machine, so as to comparatively assess the processing stability of said compounds at various temperatures, wherein the molding cycle was also halted for 5 minutes to lengthen the residence time of the materials melt in the barrel and later, the normal injection molding cycle was resumed. The intensity of the color development in specimens is considered as indicative of their heat stability under rigorous conditions, as explained above, but also the number of specimens needed to be injected to regain color serves as a parameter to that criterion. The aforementioned test is a simulation of a sudden stop of the machine for a while, an event that practically happens.

Color evaluation (initial and after sudden stop), considering DE value, were obtained in a CIELAB spectrophotometer type ACS Chroma QC Sphere Model with illuminant/observer D65/10′.

TABLE 9
PROCESSING HEAT STABILITY
AS PROJECTED BY COLOR DEVELOPMENT

| | Composition % | |
|---|---|---|
| | HIPS + FR | |
| | 1206/CrystBrEpox70:30 | HIPS + SP-75 |
| HIPS | 92.8% | 93.25% |
| Stabilized HBCD type | 4.5% | 4.2% |
| Antimony Trioxide | 2.25% | 2.1% |
| Processing Additives | 0.45% | 0.45% |
| Bromine Content % | 2.9% | 2.9% |
| Color Development | | |
| 240° C. Initial | DE = 12.4 | DE = 16.5 |
| After 5 min Shutdown | DE = 13.3 | DE = 39.5 |
| 250° C. Initial | DE = 29.7 | N/A* |
| After 5 min Shutdown | De = 47.4 | N/A* |

*no specimens could be obtained due to total collapse of compound

The results obtained clearly demonstrate the advantage of the FR 1206/CrystBrEpox70:30 over the reference SP-75. At 240° C. the HIPS+FR 1206/CrystBrEpox70:30 polymeric composition approximately maintained its initial color, whereas the color of the HIPS+SP-75 was drastically changed. At 250° C. the difference between the two examined polymeric compositions is even sharper, as the HIPS+SP-75 polymeric composition has totally collapsed.

### [0071] Example 9

The following example examines the properties of polymeric compositions comprising the HBCD stabilized formulation, FR 1206/CrystBrEpox70:30 of Example 7, or modification thereof, according to the present invention. It was found that further improvements in the thermal stability of FR 1206/CrystBrEpox70:30 formulation may be attained by the use of small amounts of secondary stabilizers complementary to the FR 1206/CrystBrEpox70:30.

The polymeric compositions were based on crystalline polystyrene, and the modified HBCD stabilized formulations comprised therein are characterized, as indicated above, by the presence of additives together with the basic formulation of FR 1206/CrystBrEpox70:30 of Example 7. The following polymeric compositions were compared:

1. Crystalline polystyrene composition comprising FR 1206/CrystBrEpox70:30 of Example 7.

2. Crystalline polystyrene composition comprising a formulation of FR 1206/CrystBrEpox70:30 with ditrimethylol propane, Irganox 1010™ and Bisphenol A, said three additional stabilizers are in 1:1:1 ratio, their total weight being about 2% of the FR 1206/CrystBrEpox70:30 formulation. This formulation will be designated in the table as “FR 1206/CrystBrEpox70:30 formulation I”.

3. Crystalline polystyrene composition comprising a formulation of FR 1206/CrystBrEpox70:30 with ditrimethylol propane, Irganox 1010™ and trisnonylphenyl phosphite, said three additional stabilizers are in 1:1:1 ratio, their total weight being about 2% of the FR 1206/CrystBrEpox70:30 formulation. This formulation will be designated in the table as “FR 1206/CrystBrEpox70:30 formulation II”.

The above compositions were prepared on a BERSTORFF twin-screw extruder at a mild temperature profile not exceeding 210° C., and these were subsequently injection molded on an ARBURG Allrounder machine at various temperatures, and with 5 minute sudden stops, as described in the Example 8, so as to evaluate the processing stability.

Color measurements, in terms of DE, were carried out on CIELAB Spectrophotometer type ACS Chroma QC illuminant/observer D65/10′.

TABLE 10
IMPROVED PROCESSING STABILITY IN POLYSTYRENE OF
FR 1206/CrystBrEpox70:30 MODIFIED FORMULATIONS

Composition %

| | | | | | | |
|---|---|---|---|---|---|---|
| Crystalline Polystyrene | 98.0% | 94.1% | 98.0% | 94.1% | 98.0% | 94.1% |
| FR 1206/CrystBrEpox70:30 | 1.5% | 5.0% | — | — | — | — |
| FR 1206/CrystBrEpox70:30 | — | — | 1.5% | 5.0% | — | — |
| formulation I | | | | | | |
| FR 1206/CrystBrEpox70:30 | — | — | — | — | 1.5% | 5.0% |
| formulation II | | | | | | |
| Processing Additives | 0.45% | 0.9% | 0.45% | 0.9% | 0.45% | 0.9% |
| Color Development | | | | | | |
| 250° C. Initial (DE) | 29.1 | 41.8 | 28.5 | 47.7 | 26.6 | 42.6 |
| After 5 min Shutdown (DE) | 31.2 | 48.9 | 32.0 | 47.0 | 28.3 | 45.0 |
| 260° C. Initial (DE) | 35.5 | — | 30.7 | — | 34.9 | — |
| After 5 min Shutdown (DE) | 48.0 | — | 35.3 | — | 38.8 | — |

The results show that FR 1206/CrystBrEpox70:30 formulation I improves the thermal stability of a polymeric composition comprising it, compared with a polymeric composition comprising FR 1206/CrystBrEpox70:30 alone, at a temperature of 260° C., whereas FR 1206/CrystBrEpox70:30 formulation II is superior to the basic formulation at 250° C.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. Flame retardant composition comprising hexabromocyclododecane and at least one halogenated epoxy resin selected from the group consisting essentially of halogenated bisphenolic epoxy resins, halogenated phenol novolac epoxy resins, halogenated cresol novolac epoxy resins, halogenated resorcinol epoxy resins, halogenated hydroquinone epoxy resins, halogenated bisphenol A novolac epoxy resins, halogenated methyl resorcinol epoxy resins and halogenated resorcinol novolac epoxy resins, said epoxy resin having an epoxy equivalent in the range between 150 and 800 g/eq.

2. The composition according to claim 1, wherein the halogenated epoxy resin is a halogenated bisphenolic epoxy resin having an average degree of polymerization in the range between 0 to 4.

3. The composition according to claim 2, wherein the halogenated bisphenolic epoxy resins are selected from among the group consisting of dibromobisphenol A, tetrabromobisphenol A, dichloro-bisphenol A, tetrachlorobisphenol A, dibromobisphenol F, tetrabromobisphenol F, dichlorobisphenol F, tetrachlorobisphenol F, dibromobisphenol S, tetrabromobisphenol S epoxy resins.

4. The composition according to claim 3, wherein the halogenated epoxy resin is represented by the general formula 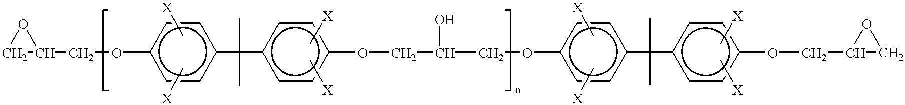
wherein n designates the average degree of polymerization, X is a halogen, said resin having an average molecular weight not higher than 1600 g/mole, and wherein the value of n is such that the said molecular weight is not exceeded.

5. The composition according to claim 4, wherein n is between 0 and 2.

6. The composition according to claim 4, wherein the average molecular weight of the halogenated epoxy resin is lower than 1600 g/mole.

7. The composition according to claim 5, wherein the average molecular weight of the halogenated epoxy resin is between 300 g/mole and 1500 g/mole.

8. The composition according to claims 4, 5, 6 or 7, wherein the halogenated epoxy resin is tetrabromobisphenol A diglycidyl ether having the general formula

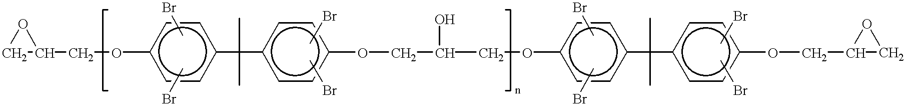

9. The composition according to claim 8 wherein the halogenated epoxy resin is tetrabromobisphenol A diglycidyl ether of the general formula 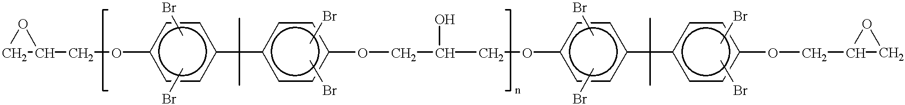
wherein n is between 0 and 0.2, is in a crystalline form having an average molecular weight of about 700 g/mole and an epoxy equivalent weight of 320 to 380 g/eq, and characterized by the presence, in the diffraction pattern, of the following seven strong diffraction peaks:
d-value, Å
9.85
4.12
4.06
4.04
3.96
3.91
and by a softening point of about 100° C. to 120° C.

10. The composition according to claim 1, comprising at least 5% of the halogenated epoxy resin.

11. The composition according to claim 1, comprising from 10 to 60% of the halogenated epoxy resin and from 40 to 90% of HBCD.

12. The composition according to claim 9, comprising about 30% of the halogenated epoxy resin and about 70% of HBCD.

13. The composition according to claim 1, further comprising fire retardant synergists.

14. The composition according to claim 13, wherein said fire retardant synergists selected from the group consisting of synergists are antimony trioxide, zinc borates, and magnesium oxide or hydroxide.

15. The composition according to claim 13, wherein the aggregate amount of halogenated epoxy resins and the HBCD is at least 20% of the total weight of the composition.

16. The composition according to claim 15, wherein the aggregate amount of halogenated epoxy resins and HBCD is between 30 and 80% of the total weight of the composition.

17. The composition according to claim 13, wherein the halogenated epoxy resins and HBCD will be in the relative proportion of at least 5/95.

18. The composition according to claim 1, wherein the halogen is bromine, the content of which is between 12 and 71% of the composition.

19. A thermal stabilizer for hexabromocyclododecane comprising a halogenated epoxy resin having the general formula:
wherein n designates the average degree of polymerization, X is halogen, said resin having an average molecular weight not higher than and preferably lower than 1600 g/mole, and wherein the value of n is such that the said average molecular weight is not exceeded; and said resin having an epoxy equivalent weight of 150 to 800 g/eq.

20. The thermal stabilizer according to claim 19, wherein n is between 0 and 2.

21. The thermal stabilizer according to claim 19, wherein X is Br.

22. The thermal stabilizer according claims 19, 20 or 21, wherein the halogen is bromine.

23. The thermal stabilizer of claim 19, wherein said halogenated epoxy resin is tetrabromobisphenol A diglycidyl ether of the general formula 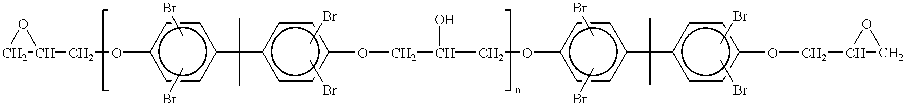
wherein n is between 0 and 0.2, is in a crystalline form having an average molecular weight of about 700 g/mole and an epoxy equivalent weight of 320 to 380 g/eq, and characterized by the presence, in the diffraction pattern, of the following seven strong diffraction peaks:
d-value, Å
9.85
9.66
4.12
4.06
4.04
3.96
3.91
and by a softening point of about 100° C. to 120° C., as thermal stabilizer of hexabromoclododecane.

24. A thermal stabilizer for hexabromocyclododecane comprising a halogenated epoxy resin having the general formula: 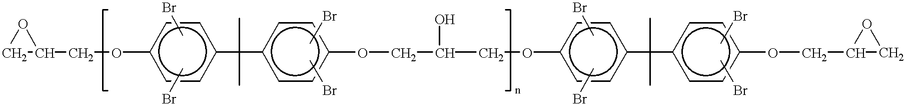
wherein n is comprised between 0 and 0.2, said resin being in a crystalline form having an average molecular weight of about 700 g/mole and an epoxy equivalent weight of 320 to 380 g/eq, and having the following diffraction peaks:
d-value, Å
9.85
9.66
4.12
4.06
4.04
3.96
3.91
and by a softening point of about 100° C. to 120° C.

25. A flame retardant composition comprising hexabromocyclododecane and a halogenated bisphenol A novalac epoxy resin, said epoxy resin having an epoxy equivalent of 150 to 500 g/eq.

26. A method for increasing thermal stability of hexabromocyclododecane, said method comprising adding to a composition comprising hexabromocyclododecane a halogenated epoxy resin having the general formula: 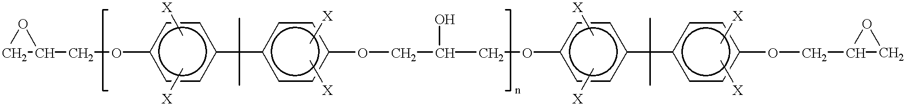
wherein n designates the average degree of polymerization, X is halogen, said resin having an average molecular weight not higher than 1600 g/mole, and wherein the value of n is such that said average molecular weight is not exceeded; and said resin having an epoxy equivalent weight of 150 to 800 g/eq.

27. A method for increasing the thermal stability of hexabromocyclododecane, comprising adding to a composition comprising hexabromocyclododecane a halogenated epoxy resin having the general formula: 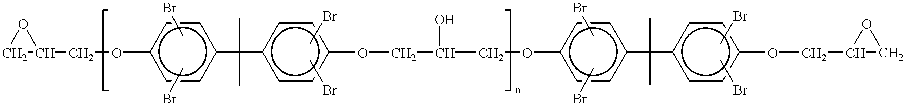
wherein n is comprised between 0 and 0.2, said resin being in a crystalline form having an average molecular weight of about 700 g/mole and an epoxy equivalent weight of 320 to 380 g/eq, and characterized by the presence, in the diffraction pattern, of the following seven strong diffraction peaks:
d-value, Å
9.85
9.66
4.12
4.06
3.96
3.91
and by a softening point of about 100° C. to 120° C.
